(19) United States
(12) Patent Application Publication
(10) Pub. No.: US 2026/0126000 A1
(43) Pub. Date: May 7, 2026

(54) CONTROL DEVICE AND INJECTION METHOD OF UREA SOLUTION

(71) Applicant: TOYOTA JIDOSHA KABUSHIKI KAISHA, Toyota-shi (JP)

(72) Inventors: Yuto IKEDA, Okazaki-shi (JP); Satoshi IDO, Toyota-shi (JP); Hibiki UEURA, Toyota-shi (JP)

(73) Assignee: TOYOTA JIDOSHA KABUSHIKI KAISHA, Toyota-shi (JP)

(21) Appl. No.: 19/302,241

(22) Filed: Aug. 18, 2025

(30) Foreign Application Priority Data
Nov. 6, 2024 (JP) 2024-194526

(51) Int. Cl. F01N 3/20; B01D 53/94

(52) U.S. Cl. CPC F01N 3/208; B01D 53/9431; B01D 53/9495; B01D 2251/2062; B01D 2251/2067; B01D 2257/404; B01D 2258/01; F01N 2610/02; F01N 2610/146; F01N 2900/1402

(57) ABSTRACT

An exhaust pipe discharges an exhaust gas discharged from a hydrogen engine to an outside of a vehicle. An exhaust gas control apparatus reduces nitrogen oxides contained in the exhaust gas. A nitrogen oxide sensor acquires a measurement value reflecting a concentration of the nitrogen oxide contained in the exhaust gas and outputs an output value that is a value obtained by subtracting, from the measurement value, a value that increases as a moisture content contained in the exhaust gas is greater. An injector injects a urea solution to the exhaust gas control apparatus. A control device is configured to cause, in a case where the output value is equal to or greater than a reference value, an injector to inject an amount of the urea solution that is determined based on the output value and a flow rate of the exhaust gas.

### CROSS-REFERENCE TO RELATED APPLICATION

This application claims priority to Japanese Patent Application No. 2024-194526 filed on Nov. 6, 2024. The disclosure of the above-identified application, including the specification, drawings, and claims, is incorporated by reference herein in its entirety.

### BACKGROUND

### 1. Technical Field

The present disclosure relates to a control device and an injection method of a urea solution.

### 2. Description of Related Art

Japanese Unexamined Patent Application Publication No. 2010-71192 (JP 2010-71192 A) discloses an exhaust system. The exhaust system includes an exhaust gas control apparatus, an injector, and a nitrogen oxide (NOx) sensor.

The exhaust gas control apparatus includes a catalyst that adsorbs ammonia. The exhaust gas control apparatus uses ammonia to reduce NOx in an exhaust gas discharged from an engine. The injector adds urea to the exhaust gas control apparatus as a reducing agent. The nitrogen oxide sensor measures a concentration of NOx in an exhaust gas flowing upstream of the exhaust gas control apparatus.

The exhaust system determines the amount of the urea solution to be injected toward the exhaust gas control apparatus by the injector based on a measurement value of the nitrogen oxide sensor. Thereafter, the exhaust system causes the injector to inject an amount of the urea solution that is determined.

The nitrogen oxide sensor also reacts to moisture in the exhaust gas in addition to NOx in the exhaust gas. Therefore, the measurement value of the nitrogen oxide sensor may be greater than a value reflecting the concentration of NOx contained in the exhaust gas.

The exhaust system corrects the measurement value of the nitrogen oxide sensor in accordance with a moisture content in the exhaust gas and then determines the amount of the urea solution to be injected by the injector.

### SUMMARY

As a mode in which the exhaust system corrects the measurement value, a mode in which an arbitrary value is subtracted from an actual measurement value obtained by the nitrogen oxide sensor and the measurement value is treated as zero in a case where the measurement value is zero or less can be considered. In this case, the exhaust system increases a value to be subtracted from the measurement value as the moisture content in the exhaust gas increases.

In a case where the engine uses hydrogen gas as a fuel, the moisture content in the exhaust gas increases. Therefore, in a case where the engine uses a hydrogen gas as a fuel, the value to be subtracted from the measurement value in the exhaust system also increases.

The degree to which the nitrogen oxide sensor reacts to the moisture in the exhaust gas changes not only depending on the moisture content in the exhaust gas but also depending on a flow velocity of the exhaust gas or the temperature of the nitrogen oxide sensor. The flow velocity of the exhaust gas or the temperature of the nitrogen oxide sensor may be a condition in which the nitrogen oxide sensor is less likely to react with the moisture, while the moisture content in the exhaust gas is large, and a value to be subtracted from the measurement value is large. In this case, even though NOx is contained in the exhaust gas, the measurement value that is corrected may be zero. In this case, the exhaust system does not cause the injector to inject the urea solution, and thus NOx passes through the exhaust gas control apparatus.

A control device for solving the above problem controls an injector by acquiring an output value of a nitrogen oxide sensor in an exhaust system.

The exhaust system includes an exhaust pipe discharging exhaust gas discharged to an outside of a vehicle from a hydrogen engine using hydrogen as a fuel.

The exhaust system includes an exhaust gas control apparatus installed in an intermediate portion of the exhaust pipe and reducing a nitrogen oxide contained in the exhaust gas.

The exhaust system includes the nitrogen oxide sensor disposed upstream of the exhaust gas control apparatus in the exhaust pipe, the nitrogen oxide sensor being configured to acquire a measurement value reflecting a concentration of the nitrogen oxide contained in the exhaust gas, and to output the output value that is a value obtained by subtracting, from the measurement value, a value that increases as a moisture content contained in the exhaust gas is greater.

The exhaust system includes the injector disposed downstream of the nitrogen oxide sensor and upstream of the exhaust gas control apparatus in the exhaust pipe, the injector being configured to inject the urea solution to the exhaust gas control apparatus.

The control device is configured to cause, in a case where the output value is equal to or greater than a reference value, the injector to inject an amount of the urea solution determined based on the output value and a flow rate of the exhaust gas.

The control device is configured to cause, in a case where the output value is lower than the reference value, the injector to inject an amount of the urea solution determined based on the reference value and the flow rate.

An injection method of a urea solution for solving the above problem is an injection method of a urea solution in an exhaust system.

The exhaust system includes an exhaust pipe discharging exhaust gas discharged to an outside of a vehicle from a hydrogen engine using hydrogen as a fuel.

The exhaust system includes an exhaust gas control apparatus installed in an intermediate portion of the exhaust pipe and reducing a nitrogen oxide contained in the exhaust gas.

The exhaust system includes the nitrogen oxide sensor disposed upstream of the exhaust gas control apparatus in the exhaust pipe, the nitrogen oxide sensor being configured to acquire a measurement value reflecting a concentration of the nitrogen oxide contained in the exhaust gas, and to output an output value that is a value obtained by subtracting, from the measurement value, a value that increases as a moisture content contained in the exhaust gas is greater.

The exhaust system includes an injector disposed downstream of the nitrogen oxide sensor and upstream of the exhaust gas control apparatus in the exhaust pipe, the injector being configured to inject a urea solution to the exhaust gas control apparatus.

The exhaust system includes a control device controlling the injector by acquiring the output value of the nitrogen oxide sensor in the exhaust system.

The injection method of a urea solution includes determining, by the control device, an amount of the urea solution to be injected by the injector based on the output value and flow rate of the exhaust gas in a case where the output value is equal to or greater than a reference value, and an amount of the urea solution to be injected by the injector based on the reference value and the flow rate in a case where the output value is lower than the reference value. The injection method of a urea solution includes injecting, by the injector, the amount of the urea solution that is determined by the control device to the exhaust gas control apparatus.

The control device and the injection method of the urea solution can reduce the amount of nitrogen oxides passing through the exhaust gas control apparatus.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a configuration of an exhaust system including a control device according to an embodiment;

FIG. 2 is a schematic diagram showing an arrangement of cells in a nitrogen oxide sensor;

FIG. 3 is a schematic diagram showing an internal structure of the nitrogen oxide sensor;

FIG. 4 is a flowchart showing a series of processes executed by the control device of FIG. 1;

FIG. 5 is a table showing an aspect in which the control device of FIG. 1 determines an amount of a urea solution to be injected by the injector; and

FIG. 6 is a graph showing an aspect in which the control device of FIG. 1 corrects the output value of the nitrogen oxide sensor, in which graph (a) shows a progression of the output value of the nitrogen oxide sensor and a reference value, graph (b) shows a progression of a urea addition amount, and graph (c) shows a progression of the nitrogen oxide concentration after the control.

### DETAILED DESCRIPTION OF EMBODIMENTS

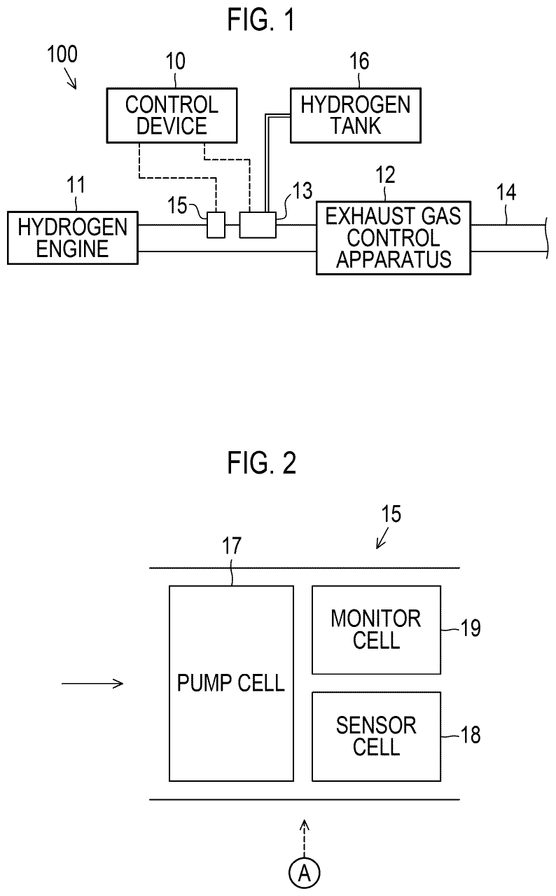

Hereinafter, an embodiment of the control device will be described with reference to FIGS. 1 to 6.

### Exhaust System 100

As shown in FIG. 1, the exhaust system 100 is applied to a vehicle including a hydrogen engine 11. The hydrogen engine 11 uses hydrogen as a fuel.

As shown in FIG. 1, the exhaust system 100 includes an exhaust pipe 14. The exhaust gas of the hydrogen engine 11 is discharged to the outside of the vehicle through the exhaust pipe 14.

As shown in FIG. 1, the exhaust system 100 includes an exhaust gas control apparatus 12. The exhaust gas control apparatus 12 is provided in an intermediate portion of the exhaust pipe 14. The exhaust gas control apparatus 12 is a selective catalytic reduction (SCR) that reduces nitrogen oxides (NOx) in an exhaust gas using ammonia (NH3) as a reducing agent. The NH3 produced by a hydrolysis of urea is adsorbed in the exhaust gas control apparatus 12.

As shown in FIG. 1, the exhaust system 100 includes a nitrogen oxide sensor 15. The nitrogen oxide sensor 15 is disposed upstream of the exhaust gas control apparatus 12 in the exhaust pipe 14. The nitrogen oxide sensor 15 measures a concentration of NOx contained in the exhaust gas.

As shown in FIG. 1, the exhaust system 100 includes an injector 13. The injector 13 is disposed downstream of the nitrogen oxide sensor 15 in the exhaust pipe 14 and upstream of the exhaust gas control apparatus 12. The injector 13 injects the urea solution toward the exhaust gas control apparatus 12 to add urea to the exhaust gas control apparatus 12.

As shown in FIG. 1, the exhaust system 100 includes a urea solution tank 16. The urea solution tank 16 is connected to the injector 13. The urea solution tank 16 stores the urea solution injected by the injector 13.

As shown in FIG. 1, the exhaust system 100 includes a control device 10. The control device 10 controls the injection of the urea solution by the injector 13.

### Configuration and Function of Nitrogen Oxide Sensor 15

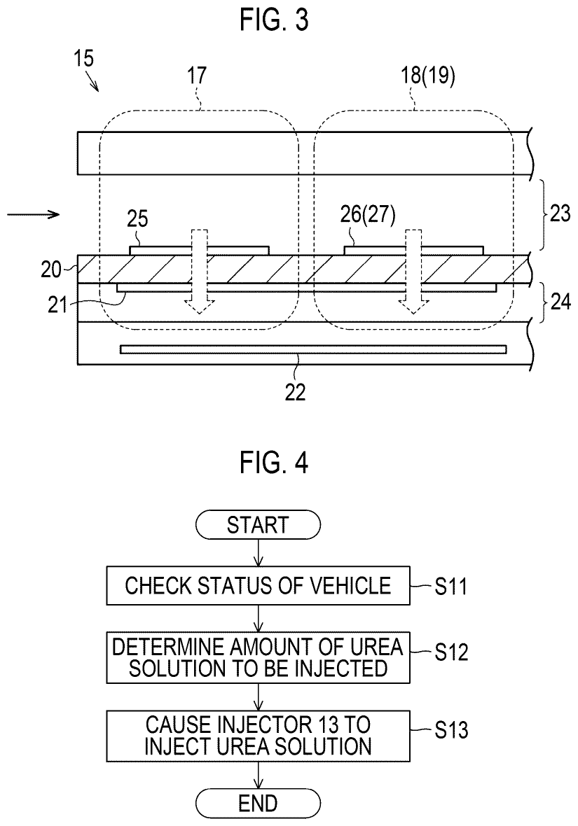

Hereinafter, the configuration and the function of the nitrogen oxide sensor 15 will be described with reference to FIGS. 2 and 3.

The nitrogen oxide sensor 15 includes a plurality of cells for measuring the concentration of NOx contained in the exhaust gas. FIG. 2 shows the arrangement of cells in the nitrogen oxide sensor 15.

As shown in FIG. 2, the nitrogen oxide sensor 15 includes a pump cell 17, a sensor cell 18, and a monitor cell 19. An arrow of a solid line in FIG. 2 indicates a direction in which the exhaust gas flows into the nitrogen oxide sensor 15.

FIG. 3 shows an internal structure of the nitrogen oxide sensor 15 in a case where the nitrogen oxide sensor 15 is viewed from a position of A in FIG. 2 toward the direction of the dotted arrow in FIG. 2.

As shown in FIG. 3, the nitrogen oxide sensor 15 is separated from a first gas chamber 23 and a second gas chamber 24. In FIG. 3, an arrow of a solid line indicates a direction in which the exhaust gas flows into the nitrogen oxide sensor 15. As shown in FIG. 3, the exhaust gas flowing into the nitrogen oxide sensor 15 passes through the first gas chamber 23.

As shown in FIG. 3, the nitrogen oxide sensor 15 includes a heater 22. As will be described later, each of the cells in the nitrogen oxide sensor 15 reacts with a component in the exhaust gas on the electrode. The heater 22 is provided to increase the temperature of the nitrogen oxide sensor 15 in a case where the temperature of the nitrogen oxide sensor 15 is low, thereby promoting a reaction on the electrode.

As shown in FIGS. 2 and 3, the exhaust gas that flows into the nitrogen oxide sensor 15 first flows into the pump cell 17 among the cells. As shown in FIG. 3, in the pump cell 17, two electrodes, that is, a pump electrode 25 and a reference electrode 21 are installed to sandwich a solid electrolyte body 20. The solid electrolyte body 20 is made of a substance through which oxygen ions pass.

The pump electrode 25 is made of a substance that has high reactivity with oxygen and low reactivity with NOx. For example, the pump electrode 25 is mainly made of platinum and gold.

When a voltage is applied to the pump electrode 25, oxygen in the exhaust gas is reduced on the pump electrode 25 to become oxygen ions. Dotted arrows in FIG. 3 indicate the direction in which the oxygen ions move. The oxygen ions generated in the pump cell 17 pass through the solid electrolyte body 20 and are released from the reference electrode 21 into the second gas chamber 24.

As described above, the pump cell 17 has a function of removing oxygen in the exhaust gas. In addition, the current flowing through the pump cell 17 reflects the oxygen concentration in the exhaust gas. Therefore, the nitrogen oxide sensor 15 can obtain the air-fuel ratio based on the current value flowing through the pump cell 17.

As shown in FIG. 2, the sensor cell 18 and the monitor cell 19 are installed side by side such that the exhaust gas passing through the pump cell 17 flows in. In FIG. 2, the sensor cell 18 is positioned in front of the monitor cell 19 as viewed from the position of A.

The sensor cell 18 and the monitor cell 19 are installed such that the solid electrolyte body 20 is sandwiched by two electrodes, in the same manner as the pump cell 17. In FIG. 3, the sensor cell 18 viewed from the position of A in FIG. 2 is shown, and a monitor cell 19 is behind the sensor cell 18.

In the monitor cell 19, two electrodes, that is, a monitor electrode 27 and the reference electrode 21 are installed to sandwich the solid electrolyte body 20. The monitor electrode 27 is made of a substance that has high reactivity with oxygen and low reactivity with NOx, as in the pump electrode 25. For example, the monitor electrode 27 is mainly made of platinum and gold.

Oxygen that cannot be removed by the pump cell 17 flows into the sensor cell 18 and the monitor cell 19. When a voltage is applied to the monitor electrode 27, oxygen in the exhaust gas is reduced on the monitor electrode 27 to become oxygen ions. The oxygen ions generated in the monitor cell 19 pass through the solid electrolyte body 20 and are released from the reference electrode 21 into the second gas chamber 24.

The current flowing through the monitor cell 19 reflects the oxygen concentration in the exhaust gas passing through the monitor cell 19. Therefore, the nitrogen oxide sensor 15 can obtain the oxygen concentration in the exhaust gas passing through the pump cell 17 based on the current value flowing through the monitor cell 19.

In the sensor cell 18, two electrodes, that is, a sensor electrode 26 and the reference electrode 21 are installed to sandwich the solid electrolyte body 20. The sensor electrode 26 is made of a substance having high reactivity with NOx. For example, the sensor electrode 26 is mainly made of platinum and rhodium.

When a voltage is applied to the sensor electrode 26, NOx in the exhaust gas is reduced on the sensor electrode 26 to generate oxygen ions. The oxygen ions generated in the sensor cell 18 pass through the solid electrolyte body 20 and are released from the reference electrode 21 into the second gas chamber 24.

The current flowing through the sensor cell 18 reflects the concentration of NOx in the exhaust gas. Therefore, the nitrogen oxide sensor 15 can obtain the concentration of NOx in the exhaust gas based on the current value flowing through the sensor cell 18.

In the sensor electrode 26, in addition to NOx, oxygen passing through the pump cell 17 also reacts with the sensor electrode 26 to generate oxygen ions. Therefore, the nitrogen oxide sensor 15 can measure the concentration of NOx in the exhaust gas by calculating the difference between the current value of the sensor cell 18 and the current value of the monitor cell 19. In this manner, the nitrogen oxide sensor 15 can acquire the measurement value reflecting the concentration of NOx contained in the exhaust gas.

### Output Method of Output Value of Nitrogen Oxide Sensor 15

The sensor electrode 26 also reacts with moisture in the exhaust gas in addition to NOx and oxygen. The moisture that reacts with the sensor electrode 26 generates oxygen ions. Therefore, the measurement value in the nitrogen oxide sensor 15 is greater than the actual concentration of NOx contained in the exhaust gas.

The nitrogen oxide sensor 15 outputs an output value based on the acquired measurement value. The output value is a value obtained by correcting a measurement value in consideration of moisture in the exhaust gas.

The amount of moisture contained in the exhaust gas can be estimated from the air-fuel ratio. The nitrogen oxide sensor 15 stores a map indicating a relationship between, for example, an air-fuel ratio that is measured in advance and an amount of moisture contained in the exhaust gas of the hydrogen engine 11.

The nitrogen oxide sensor 15 measures the air-fuel ratio based on the current value of the pump cell 17. Thereafter, the nitrogen oxide sensor 15 estimates the moisture content in the exhaust gas based on the air-fuel ratio that is acquired.

The nitrogen oxide sensor 15 estimates the moisture content in the exhaust gas and corrects the measurement value according to the moisture content that is estimated to output the output value. Specifically, the nitrogen oxide sensor 15 outputs a value obtained by subtracting an arbitrary value from the measurement value as an output value, and in a case where the output value is zero or less, the output value is treated as zero. At this time, the nitrogen oxide sensor 15 increases a value to be subtracted from the measurement value according to the moisture content that is estimated.

### Function of Control Device 10

As shown in FIG. 1, the control device 10 is communicably connected to the injector 13 and the nitrogen oxide sensor 15. The control device 10 acquires an output value from the nitrogen oxide sensor 15. The control device 10 determines an amount of the urea solution to be injected by the injector 13 based on the output value that is acquired, and then causes the injector 13 to inject the amount of the urea solution that is determined.

As described above, the output value is a value obtained by subtracting a larger value as the moisture content in the exhaust gas increases from the measurement value. The hydrogen engine 11 uses hydrogen as a fuel, and thus the exhaust gas contains a large amount of moisture. Therefore, when the output value is output, the value to be subtracted from the measurement value by the nitrogen oxide sensor 15 is likely to be large.

On the other hand, in the sensor cell 18, the degree to which the moisture reacts with the sensor electrode 26 is also affected by the temperature of the nitrogen oxide sensor 15 and the flow velocity of the exhaust gas. As the temperature of the nitrogen oxide sensor 15 is lower, the degree of reaction of the moisture with the sensor electrode 26 is reduced. The slower the flow velocity of the exhaust gas, the lower the degree of reaction of the moisture with the sensor electrode 26. Therefore, depending on the temperature of the nitrogen oxide sensor 15 or the condition of the flow velocity of the exhaust gas, the value to be subtracted at the time of outputting the output value becomes excessively large. In the vehicle to which the hydrogen engine 11 is applied, the value to be subtracted when the output value is output is likely to be excessively large because the value to be subtracted from the measurement value by the nitrogen oxide sensor 15 is likely to be large.

In addition, as described above, in a case where the temperature of the nitrogen oxide sensor 15 is low, the heater 22 is operated such that the electrode and the component in the exhaust gas sufficiently react with each other. Since the exhaust gas by the hydrogen engine 11 contains a large amount of moisture, the temperature of the exhaust gas is likely to be low. Therefore, since the number of times of operation of the heater 22 increases, the heater 22 is likely to deteriorate with the passage of time. When the heater 22 deteriorates with the passage of time, since the reactivity between the electrode and the component in the exhaust gas is reduced, the reactivity between NOx and the sensor electrode 26 in the sensor cell 18 is reduced.

As described above, in the vehicle to which the hydrogen engine 11 is applied, the output value of the nitrogen oxide sensor 15 tends to be small. Therefore, even though NOx is contained in the exhaust gas, the output value after the value is subtracted from the measurement value and corrected may be zero or less. The control device 10 determines, in consideration of such circumstances, the amount of the urea solution to be injected by the injector 13 while correcting the output value according to the condition in the vehicle.

### Mode of Processing by Control Device 10

FIG. 4 shows a series of processes executed by the control device 10. The control device 10 executes a series of processing shown in FIG. 4 at a constant time interval while the hydrogen engine 11 is in operation.

In the process of S11, the control device 10 checks the status of the vehicle. At this time, the control device 10 checks whether the fuel cut is being performed as the status of the vehicle. The control device 10 checks whether the nitrogen oxide sensor 15 is active as the status of the vehicle. The control device 10 checks an operation status of the hydrogen engine 11 including an intake air amount of the hydrogen engine 11 as the status of the vehicle. The control device 10 that checks the status of the vehicle proceeds to S12 of the process.

In the process of S12, the control device 10 determines the amount of the urea solution to be injected by the injector 13. In order for the exhaust gas control apparatus 12 to sufficiently reduce NOx in the exhaust gas, it is desirable that the more NOx is included in the exhaust gas, the more urea solution is injected the more urea is added to the exhaust gas control apparatus 12. The control device 10 determines the amount of the urea solution to be injected by the injector 13 based on the concentration of NOx in the exhaust gas and the flow rate of the exhaust gas.

The control device 10 estimates the flow rate of the exhaust gas from the intake air amount in the vehicle, for example. The control device 10 changes the type of the value used as the concentration of NOx in the exhaust gas according to the status of the vehicle.

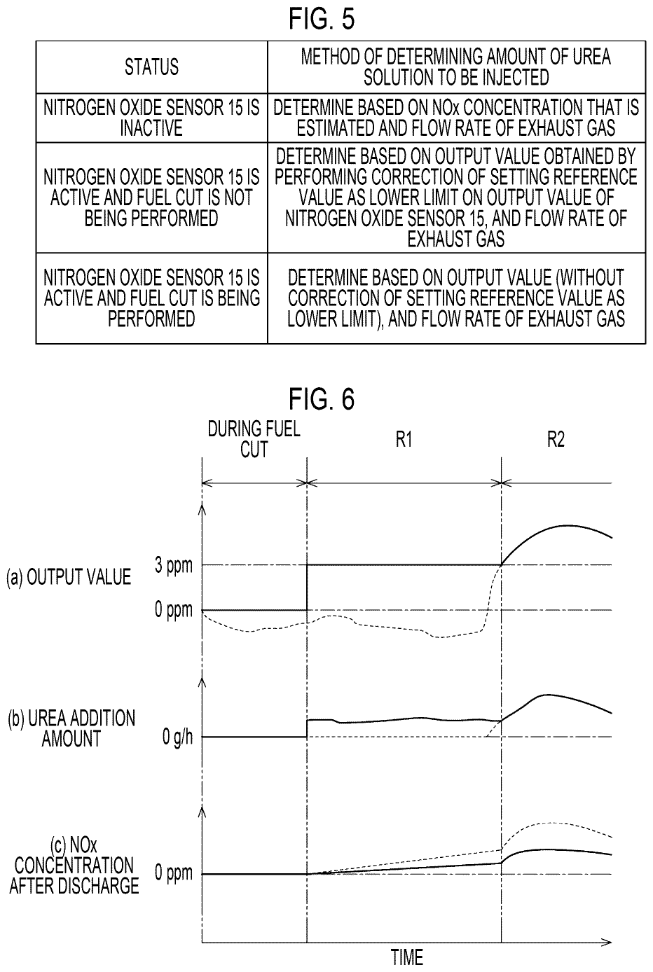

FIG. 5 shows an aspect in which the control device 10 determines the amount of the urea solution to be injected by the injector 13 in the process of S12.

The measurement value and the output value output when the nitrogen oxide sensor 15 is not in the active state do not accurately reflect the concentration of NOx in the exhaust gas. As shown in FIG. 5, the control device 10 determines the amount of the urea solution to be injected based on the NOx concentration that is estimated and the flow rate of the exhaust gas when the nitrogen oxide sensor 15 is inactive.

The concentration of NOx included in the exhaust gas can be estimated from the operating state of the hydrogen engine 11. The operating state of the hydrogen engine 11 is, for example, the magnitude of the torque output by the hydrogen engine 11 or a rotation speed of the hydrogen engine 11. The control device 10 outputs the estimated NOx concentration by referring to, for example, a map created in advance and indicating a relationship between the operating state of the hydrogen engine 11 and the concentration of NOx contained in the exhaust gas. The operating state of the hydrogen engine 11 includes, in addition to the intake air amount, for example, a rotation speed of an output shaft of the hydrogen engine 11, a valve timing of intake and exhaust valves, an ignition timing, an opening degree of an EGR valve, and an exhaust temperature.

As shown in FIG. 5, the control device 10 may be in a state where the nitrogen oxide sensor 15 is active and the fuel cut is not being performed. In this case, the control device determines the amount of urea solution to be injected based on an output value obtained by correcting the output value from the nitrogen oxide sensor 15 such that the reference value is set as a lower limit value, and the flow rate of the exhaust gas.

As described above, in the vehicle to which the hydrogen engine 11 is applied, the output value may be zero or less even though NOx is contained in the exhaust gas. The control device 10 performs correction on the output value such that the reference value that is greater than zero is set as a lower limit value in a case where the nitrogen oxide sensor 15 is active and the fuel cut is not being performed.

FIG. 6 shows a progression of an output value of the nitrogen oxide sensor 15, an amount of urea added to the exhaust gas control apparatus 12, and a concentration of NOx contained in the exhaust gas cleaned by the exhaust gas control apparatus 12. In FIG. 6, a value less than zero ppm is output as an output value. However, in the control device 10, an output value less than zero ppm is treated as zero ppm.

In FIG. 6, the graph (a) shows with a broken line the progression of output values uncorrected by control device 10 and with a solid line the progression of output values used by control device 10 when determining the amount of the urea solution to be injected.

In FIG. 6, the periods indicated by R1 and R2 indicate periods in which the nitrogen oxide sensor 15 is active and the fuel cut is not being performed.

In the graph (a) of FIG. 6, the reference value is 3 ppm. The reference value is determined based on the concentration of NOx contained in the exhaust gas when the vehicle is idling.

During the period of R1 in the graph (a) of FIG. 6, the output value is progressing to be less than the reference value. As shown in the graph (a) of FIG. 6, the control device 10 corrects the output value as an output value that is the reference value when the output value is less than the reference value. That is, the control device 10 determines the amount of the urea solution to be injected based on the reference value and the flow rate of the exhaust gas when the output value is lower than the reference value in the period in which the nitrogen oxide sensor 15 is active and the fuel cut is not being performed.

In the period of R2 in the graph (a) of FIG. 6, the output value is progressing the reference value or more. As shown in FIG. 6, the control device 10 does not correct the output value in a case where the output value is equal to or greater than the reference value. That is, the control device 10 determines the amount of the urea solution to be injected based on the output value and the flow rate of the exhaust gas when the output value is equal to or greater than the reference value in the period in which the nitrogen oxide sensor 15 is active and the fuel cut is not being performed.

As shown in FIG. 5, the control device 10 determines the amount of the urea solution to be injected based on the output value of the nitrogen oxide sensor 15 and the flow rate of the exhaust gas in a case where the nitrogen oxide sensor 15 is active and the fuel cut is being performed. FIG. 6 shows a period during which fuel cut is performed. As shown in the graph (a) of FIG. 6, during the period in which the fuel cut is being performed, the control device 10 does not perform the correction of setting the reference value as the lower limit value on the output value. As described above, in this case, the control device 10 treats the output value of less than zero ppm as zero ppm.

The control device 10 that determines the amount of the urea solution to be injected in the above-described manner proceeds to S13 of the process. In the process of S13, the control device 10 causes the injector 13 to inject the amount of the urea solution that is determined in the process of S12. Thereafter, the control device 10 ends the series of process shown in FIG. 4.

As described above, the control device 10 determines the amount of the urea solution to be injected based on the output value on which the correction of setting the reference value as the lower limit value is performed even when the output value is less than zero, as long as the condition that is predetermined is satisfied.

In the graph (b) of FIG. 6, a progression of the amount of urea to be added in a case where the amount of the urea solution to be injected is determined based on the previous output value corrected by the control device 10 is shown with a broken line. In the graph (b) of FIG. 6, the progression of the amount of urea added when the amount of the urea solution to be injected is determined based on the output value corrected by the control device 10 is shown with a solid line. As shown in the graph (b) of FIG. 6, the control device 10 can cause the injector 13 to add the urea by correcting the output value even in a period in which the urea cannot be added by correcting the output value.

In the graph (c) of FIG. 6, a progression of the concentration of NOx contained in the exhaust gas after passing through the exhaust gas control apparatus 12 is shown with a broken line in a case where the amount of the urea solution to be injected is determined based on the output value before correction by the control device 10. In the graph (c) of FIG. 6, a progression of the concentration of NOx contained in the exhaust gas after passing through the exhaust gas control apparatus 12 is shown with a solid line in a case where the amount of the urea solution to be injected is determined based on the output value corrected by the control device 10. As shown in the graph (c) of FIG. 6, in a case where the output value is not corrected, urea is not added even in a case where NOx is contained in the exhaust gas, but in a case where the output value is corrected, since urea is added, the discharge of NOx to the outside of the vehicle can be reduced.

### Operation of Present Embodiment

The control device 10 causes the injector 13 to inject the urea solution by providing a certain lower limit value in the output value of the nitrogen oxide sensor 15, even in a case where the output value of the nitrogen oxide sensor 15 would be zero.

### Effect of Embodiment

(1) The control device 10 can reduce the amount of NOx passing through the exhaust gas control apparatus 12.
(2) The control device 10 causes the injector 13 to inject, during the fuel cut, the amount of the urea solution that is determined based on the output value and the flow rate. During the fuel cut, the hydrogen engine 11 does not discharge NOx. Therefore, during the fuel cut, it is desirable that the injector 13 does not inject the urea solution when the output value of the nitrogen oxide sensor 15 is zero. During the fuel cut, the control device 10 determines the amount of the urea solution to be injected by the injector 13 based on an output value without a lower limit value rather than on an output value with a lower limit value. Accordingly, the control device 10 can inhibit the injector 13 from injecting the urea solution in a case where hydrogen engine 11 does not produce NOx.
(3) The reference value is determined based on a concentration of NOx contained in the exhaust gas when the vehicle is idling. In a case where the reference value is large, the probability that the injector 13 injects an excessive amount of the urea solution with respect to the concentration of NOx contained in the exhaust gas is high. The control device 10 uses a reference value determined based on the concentration of NOx discharged from the hydrogen engine 11 when the vehicle is idling. Accordingly, the control device 10 can suppress the injector 13 from excessively injecting the urea solution.
(4) In a case where the nitrogen oxide sensor 15 is in the inactive state, the concentration of NOx contained in the exhaust gas is estimated based on the operating state of the hydrogen engine 11. The control device 10 causes the injector 13 to inject the amount of the urea solution that is determined based on the concentration of NOx that is estimated and the flow rate.

The measurement value and the output value output when the nitrogen oxide sensor 15 is not in the active state do not accurately reflect the concentration of NOx in the exhaust gas. In a case where the nitrogen oxide sensor 15 is not in the active state, the control device 10 determines the amount of the urea solution to be injected by the injector 13 based on the concentration of NOx estimated by the control device 10, instead of using the measurement value and the output value. Accordingly, the control device 10 can determine the amount of the urea solution to be injected by the injector 13 more accurately.
(5) The exhaust system 100 includes an exhaust pipe 14, an exhaust gas control apparatus 12, a nitrogen oxide sensor 15, an injector 13, and a control device 10. The exhaust pipe 14 discharges an exhaust gas discharged from the hydrogen engine 11 using hydrogen as a fuel to the outside of the vehicle. The exhaust gas control apparatus 12 is installed in the exhaust pipe 14 and reduces NOx contained in the exhaust gas. The nitrogen oxide sensor 15 is disposed upstream of the exhaust gas control apparatus 12 in the exhaust pipe 14. The nitrogen oxide sensor 15 acquires a measurement value reflecting the concentration of NOx contained in the exhaust gas and outputs an output value that is a value obtained by subtracting, from the measurement value, a value that increases as a moisture content contained in the exhaust gas is greater. The injector 13 is disposed downstream of the nitrogen oxide sensor 15 in the exhaust pipe 14 and upstream of the exhaust gas control apparatus 12, and injects the urea solution into the exhaust gas control apparatus 12. The control device 10 controls the injector 13 by acquiring the output value of the nitrogen oxide sensor 15. In the injection method of a urea solution, the control device 10 determines an amount of a urea solution to be injected by the injector 13 based on the output value and flow rate of the exhaust gas in a case where the output value is equal to or greater than a reference value. Also, the injecting method of a urea solution includes a step of determining an amount of a urea solution to be injected by the injector 13 based on the reference value and the flow rate of the exhaust gas in a case where the output value is lower than the reference value (S12). The injecting method of a urea solution includes a step of injecting, by the injector 13, the amount of the urea solution that is determined by the control device 10 to the exhaust gas control apparatus 12 (S13).

The injecting method of a urea solution causes the injector 13 to inject the urea solution by providing a certain lower limit value in the output value of the nitrogen oxide sensor 15, even in a case where the output value of the nitrogen oxide sensor 15 would be zero. Accordingly, the injection method of the urea solution can reduce the amount of NOx passing through the exhaust gas control apparatus 12.

### Modification

The embodiment described above can be modified and carried out as follows. The embodiment described above and the following modifications can be carried out in combination within a technically consistent range.

In the above-described embodiment, the control device 10 may be in a state in which the nitrogen oxide sensor 15 is active and the fuel cut is being performed. In this case, the amount of the urea solution to be injected by the injector 13 is determined based on the output value on which the correction of setting the reference value as a lower limit is performed and the flow rate of the exhaust gas.

The control device 10 may cause the injector 13 to inject the amount of the urea solution that is determined based on the output value on which the correction of setting the reference value as a lower limit is performed and the flow rate even in a case where the nitrogen oxide sensor 15 is active and the fuel cut is being performed.

Further, the control device 10 may adopt a mode in which the urea solution is not uniformly injected by the injector 13 regardless of the output value and the flow rate in a case where the nitrogen oxide sensor 15 is active and the fuel cut is being executed.

The reference value may not be determined based on the concentration of NOx contained in the exhaust gas when the vehicle is idling. For example, the reference value may be arbitrarily determined by the designer of the control device 10.

In the above-described embodiment, the control device 10 determines the amount of the urea solution based on the concentration of NOx that is estimated and the flow rate of the exhaust gas when the nitrogen oxide sensor 15 is inactive. On the other hand, the control device 10 may determine the amount of the urea solution based on the output value and the flow rate of the exhaust gas even in a case where the nitrogen oxide sensor 15 is inactive.

What is claimed is:

1. A control device controlling an injector by acquiring an output value of a nitrogen oxide sensor in an exhaust system including an exhaust pipe discharging exhaust gas discharged to an outside of a vehicle from a hydrogen engine using hydrogen as a fuel, an exhaust gas control apparatus installed in an intermediate portion of the exhaust pipe and reducing a nitrogen oxide contained in the exhaust gas, the nitrogen oxide sensor disposed upstream of the exhaust gas control apparatus in the exhaust pipe, the nitrogen oxide sensor being configured to acquire a measurement value reflecting a concentration of the nitrogen oxide contained in the exhaust gas, and to output the output value that is a value obtained by subtracting, from the measurement value, a value that increases as a moisture content contained in the exhaust gas is greater, and the injector disposed downstream of the nitrogen oxide sensor and upstream of the exhaust gas control apparatus in the exhaust pipe, the injector being configured to inject a urea solution to the exhaust gas control apparatus, wherein the control device is configured to:
cause, in a case where the output value is equal to or greater than a reference value, the injector to inject an amount of the urea solution determined based on the output value and a flow rate of the exhaust gas; and
cause, in a case where the output value is lower than the reference value, the injector to inject an amount of the urea solution determined based on the reference value and the flow rate.

2. The control device according to claim 1, wherein the control device is configured to cause the injector to inject, during a fuel cut, the amount of the urea solution determined based on the output value and the flow rate.

3. The control device according to claim 1, wherein the reference value is determined based on a concentration of the nitrogen oxide contained in the exhaust gas when the vehicle is idling.

4. The control device according to claim 1, wherein the control device is configured to:
estimate, in a case where the nitrogen oxide sensor is in an inactive state, a concentration of a nitrogen oxide contained in the exhaust gas based on an operating state of the hydrogen engine; and
cause the injector to inject an amount of the urea solution determined based on the concentration of the nitrogen oxide that is estimated and the flow rate.

5. An injection method of a urea solution in an exhaust system including an exhaust pipe discharging exhaust gas discharged to an outside of a vehicle from a hydrogen engine using hydrogen as a fuel, an exhaust gas control apparatus installed in an intermediate portion of the exhaust pipe and reduces nitrogen oxides contained in the exhaust gas, a nitrogen oxide sensor disposed upstream of the exhaust gas control apparatus in the exhaust pipe, the nitrogen oxide sensor being configured to acquire a measurement value reflecting a concentration of nitrogen oxides contained in the exhaust gas, and to output an output value that is a value obtained by subtracting, from the measurement value, a value that increases as a moisture content contained in the exhaust gas is greater, an injector disposed downstream of the nitrogen oxide sensor and upstream of the exhaust gas control apparatus in the exhaust pipe, the injector being configured to inject the urea solution to the exhaust gas control apparatus, and a control device controlling the injector by acquiring the output value of the nitrogen oxide sensor, the injection method comprising:
determining, by the control device, an amount of the urea solution to be injected by the injector based on the output value and a flow rate of the exhaust gas in a case where the output value is equal to or greater than a reference value, and an amount of the urea solution to be injected by the injector based on the reference value and the flow rate in a case where the output value is lower than the reference value; and
injecting, by the injector, the amount of the urea solution that is determined by the control device to the exhaust gas control apparatus.
